(19) United States
(12) Patent Application Publication
(10) Pub. No.: US 2006/0262960 A1
(43) Pub. Date: Nov. 23, 2006

(54) Method and device for tracking objects in a sequence of images

(76) Inventors: Francois Le Clerc, Rennes (FR); Pierrick Jouet, Rennes (FR); Philippe Robert, Thorigne Fouillard (FR)

Correspondence Address: THOMSON LICENSING INC., PATENT OPERATIONS, PO BOX 5312, PRINCETON, NJ, 08543-5312, US

(21) Appl. No.: 11/416,025

(22) Filed: May 2, 2006

(30) Foreign Application Priority Data
May 10, 2005 (FR) 05/51184

(51) Int. Cl. G06K 9/00; G06K 9/34

(52) U.S. Cl. 382/103; 382/173

(57) ABSTRACT

The invention relates in particular to a method of tracking an object in a sequence of images, each image comprising pixels with each of which is associated at least one value in a determined representation space, termed the colour space. This method comprises the following steps: segmenting, in the spatial domain, the object in an image of the sequence, termed the reference image, by estimation of its contour; and tracking the contour of the object in the other images of the sequence on the basis of the values associated, in the color space, with the pixels of the object segmented in the reference image.

### 1. FIELD OF THE INVENTION

The invention relates to a device and a method for tracking objects in a sequence of images. This invention applies in particular to the field of post-production of sequences of images.

### 2. BACKGROUND OF THE INVENTION

Numerous applications may make it necessary to segment and to track objects in a sequence of images in particular in the field of post-production, of video coding and of video indexing. The segmentation and the tracking of objects which may be of complex shape constitute two problems in image processing which are, currently, imperfectly solved. Specifically, the current solutions do not make it possible to attain by automated processings the degree of accuracy and of robustness required for post-production applications. Thus, the segmentation and tracking tools available in post-production platforms, in particular for applications dedicated to colour correction, are slow and irksome to use. Considerable involvement of a human operator is in fact necessary to obtain results of acceptable quality. In these platforms, the object is segmented using an approach, termed the “region” approach, which consists in isolating the object from the background on the basis of its colorimetric content. The operator seeks to isolate in a predetermined colour representation space, such as Hue, Saturation, Luminance (HSL), a domain which contains all the colours of the object but none of the colours of the background. He proceeds by successive refinements of the definition of this colour domain, guided by a visual representation on the image—for example highlighted—of the pixels whose colour is located inside the selected domain. All these pixels must ideally coincide, at the end of the refinement process, with the region of the image corresponding to the object to be segmented. Even when the process is restricted to a window bounding the object, segmentation on the basis of colour is generally a slow and irksome operation requiring considerable involvement of the operator.

### 3. SUMMARY OF THE INVENTION

The invention has the aim of alleviating at least one of these drawbacks. More particularly, the invention has the objective of reducing the involvement of the human operator by proposing an at least partially automated processing for segmentation and object tracking combining the effectiveness of segmentation based on the estimation of the boundary or contour of the object with the robustness of tracking of the colour domain associated with the object.

For this purpose, the present invention proposes a method of tracking an object in a sequence of images, each image comprising pixels or image points with each of which is associated at least one value in a determined representation space, termed the colour space. The method comprises the following steps:
segmenting, in the spatial domain, the object in an image of the sequence, termed the reference image, by estimation of its contour; and
tracking the contour of the object in the other images of the sequence on the basis of the values associated, in the color space, with the pixels of the object segmented in the reference image.

Preferably, the step of tracking the contour of the object comprises the following steps:
determining an object domain in the colour space representative of the segmented object in the reference image;
determining a window bounding the object, termed the bounding box, in the reference image;
tracking the position of the bounding box in the other images of the sequence; and
segmenting the object in the other images of the sequence on the basis of the position of the bounding box in each of the other images and on the object domain in the colour space.

Advantageously, the step of segmenting the object in the other images of the sequence consists, for an image of the sequence, in associating with each pixel of the image located inside the bounding box a label indicating if the value associated with the pixel belongs or does not belong to the object domain defined in the colour space.

Advantageously, the step of tracking the bounding box is performed using a particular region filtering algorithm based on the colour of the region.

According to a particular characteristic, the step of segmenting the object in the reference image is performed using an algorithm based on active contours.

According to another characteristic, the step of segmenting the object in the reference image is performed using an algorithm based on level sets.

Preferably, the reference image is the first image of the sequence and the colour space lies in the following set:
(red, green, blue);
(hue, saturation, luminance) ; and
(hue, saturation, value).

The invention also relates to a device for tracking an object in a sequence of images, each image comprising pixels or image points with each of which is associated at least one value in a determined representation space, termed the colour space. The device comprises:
means for segmenting, in the spatial domain, the object in an image of the sequence, termed the reference image, by estimation of its contour; and
means for tracking the contour of the object in the other images of the sequence on the basis of the values associated, in the color space, with the pixels of the object segmented in the reference image.

The invention also relates to a device for post-production of sequences of images which comprises means for processing the sequence, and a device for object tracking. The processing means are for example colour correction means.

### 4. BRIEF DESCRIPTION OF THE DRAWINGS

The invention will be better understood and illustrated by means of advantageous examples of embodiments and of implementation, wholly nonlimiting, with reference to the appended figures in which:

FIG. 1 illustrates a method of segmenting and tracking objects according to the invention;

FIG. 2 presents a block diagram of the steps for tracking objects;

FIG. 3 represents a view of the active contour and of the contour of the object that one seeks to estimate

FIG. 4 shows an exemplary device implementing the method of segmenting and tracking objects ; and

FIG. 5 represents the block diagram of a device for post-production of sequences of images.

### 5. DETAILED DESCRIPTION OF THE DRAWINGS

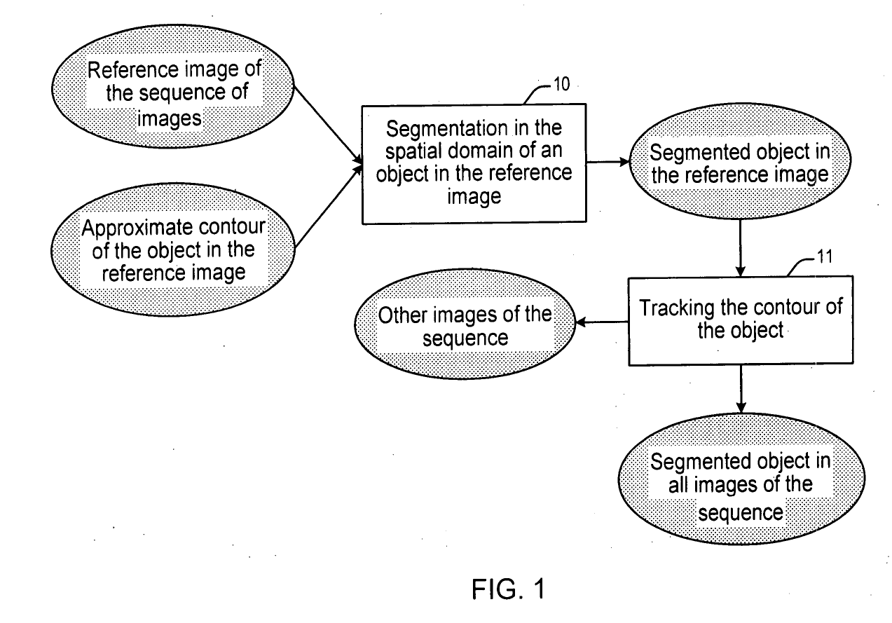

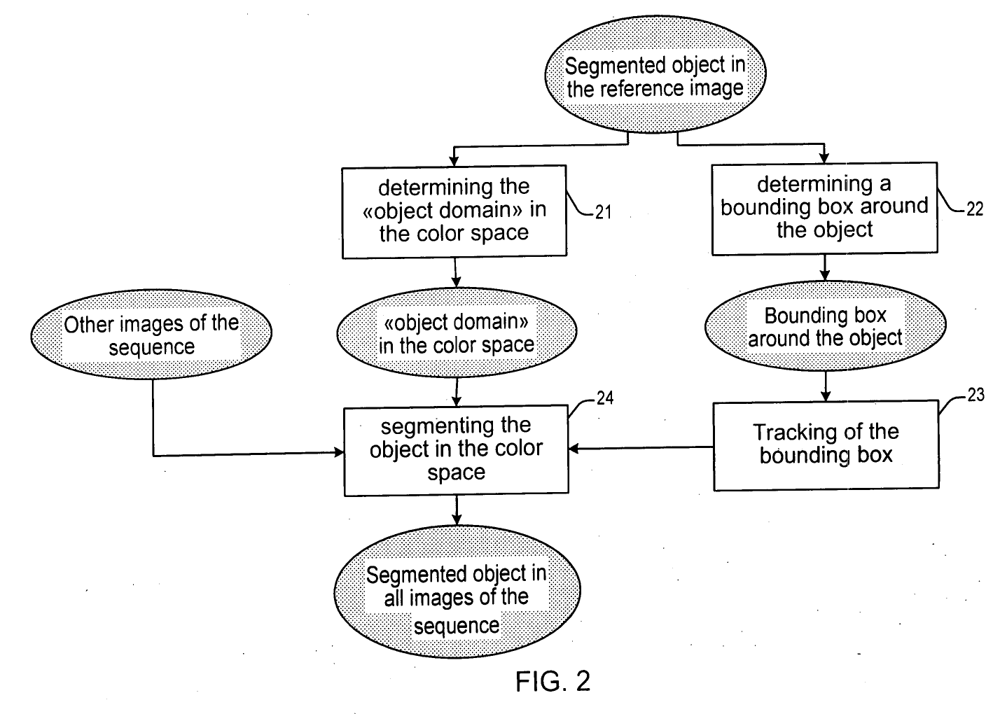

The invention relates to a method of segmenting and tracking objects in a sequence of images, called source images. Each image of the sequence comprises pixels or image points. With each pixel is associated at least one value (for example a luminance value) in a particular colour representation space, termed the colour space. For example, three values are associated with each pixel of the image in the following colour spaces: RGB Red Green Blue space, HSL hue, saturation, luminance space, HSV hue, saturation, value space. It is also conceivable to work with colour spaces in which more than three values are associated with a pixel of the image without this modifying the method according to the invention. Hereinafter, to simplify the description, a single object to be segmented is considered. The method can be extended in a direct manner to several objects as long as these objects remain disjoint throughout the sequence in which the tracking is performed. The method of segmenting and tracking objects is described by FIGS. 1 and 2. In these figures, the modules represented are functional units, which may or may not correspond to physically distinguishable units. For example, these modules or some of them may be grouped together in a single component, or constitute functionalities of one and the same piece of software. A contrario, certain modules may possibly be composed of separated physical entities. The method according to the invention splits into two main steps:
a first step 10 of segmentation of the object in at least one reference image (for example the first source image of the sequence), the segmentation being performed by estimation of the contour of the object in the domain of the image or spatial domain; and
a step 11 of tracking the contour of the object in the colour space.
   Possibly, the segmentation step 10 makes it possible to generate a segmentation mask. This mask is a binary image which associates with each pixel of a source image a label (“object” label or “background” label) representative of whether or not the pixel belongs to the segmented object. Step 11 comprises several steps referenced 21 to 24 in FIG. 2. These steps consist in defining a domain, in the colour space, comprising the value associated with the pixels located inside the contour of the object obtained at step 10 and discriminating these pixels from those located in the background. This domain is thereafter tracked along the processed sequence, the segmentation of the object in each source image of the sequence being obtained by the identification of the pixels located inside the domain of the colour space calculated in the reference image.

This hybrid solution combines segmentation in the spatial domain, which is faster and less irksome for the operator than segmentation based on discrimination of colours, and tracking in the colour space, which is more robust to variations in shape than tracking of the contour of the object by motion estimation in the spatial domain. It consequently makes it possible to reduce the overall intervention of the user in the segmentation and object tracking process, and to improve the effectiveness thereof.

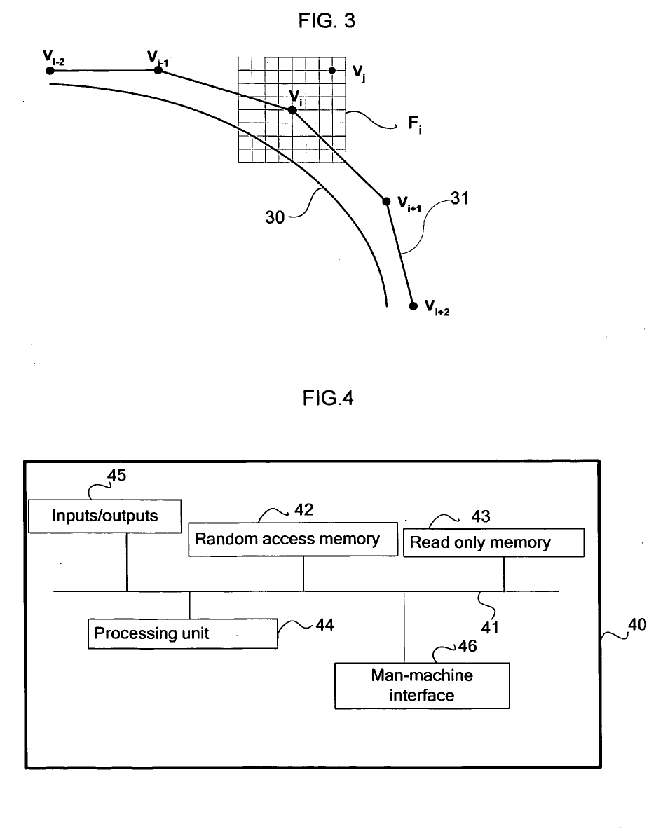

The first step 10 of the method consists in performing a discrimination between the object and the background, in a reference image (for example the first image of the sequence), by estimating the boundary of the object between the object and the background in the image. This boundary is also called the contour of the object. For this purpose, it is advantageous to use image processing algorithms based on active contours (also called “snakes”) or level sets. These algorithms enable an approximation of the contour of the object to be made to converge automatically to its exact contour. According to the active contours approach, an approximation of the contour of the object is provided by the operator in the form of a parametrized curve—for example a polygon—defined by control points—the vertices of the polygon. More precisely, when an operator wants to segment an object that he displays on a screen, he plots an approximate contour of the boundaries of the object outside the object. By using an image processing algorithm based on active contours, the initial approximate contour converges to the real contour of the object to be segmented. FIG. 3 represents the contour 30 of the object to be segmented and the active contour 31 at the start of the convergence process or at an intermediate stage of the latter. The active contour is defined by a certain number of control points Vᵢ corresponding to the ends of the arcs forming this active contour. In the case where the active contour is modelled by a polygon, these arcs are straight line segments, and the set of the control points comprises the ends of these segments. The number of control points, referenced Vᵢ in FIG. 3, varies as a function of the complexity of the contour of the object. An active contour is defined as a parametrized curve in an image, which iteratively approaches the contour of an object under the influence of internal forces, calculated on the basis of the active contour curve itself, and of external forces, which depend on the image. The internal forces constrain the shape of the curve to satisfy regularity constraints, the external forces optimize the positioning of the curve in relation to the content of the image. The application of these forces manifests itself by the minimization of a functional called the energy. Although it is theoretically possible to seek simultaneous convergence of the whole set of control points by performing a global minimization of the energy functional, the convergence of the active contour is in practice achieved with the aid of a greedy algorithm proposed initially in the article by D. J. Williams and M. Shah, entitled “A Fast Algorithm for Active Contours and Curvature Estimation>>, published in the CVGIP journal: Image Understanding, volume 55 no. 1, January 1992, pages 14 to 26. According to this algorithm, the minimization of the energy is performed iteratively on each of the control points, until the stabilization of the active contour. With reference to FIG. 3, Vᵢ represents the current position of a control point of the active contour. The greedy algorithm consists therefore in making Vᵢ converge towards the contour of the object by calculating, for each point Vⱼ of a search window Fᵢ defined in the neighbourhood of Vᵢ, the energy of the active contour obtained by replacing Vᵢ by Vⱼ, and by selecting as new control point the one, located in the window Fᵢ, which provides the minimum energy. Each point inside this window is a candidate point for the position of the new control point. The control point is therefore moved in the window towards the candidate point for which the energy is minimum. This process is applied successively to all the control points, until convergence of the active contour. The size of the window can, for example, be fixed at 21 pixels by 21 pixels. In other embodiments, the size of the window can be different. The size of the window to be used depends on the application aimed at and on the resolution of the image processed. Typically, the window will be all the larger the higher the resolution, so as to maintain at a reasonable level the degree of accuracy required for the initial approximation.

The energy E(i, Vⱼ) of the control point Vᵢ is defined for example, for each candidate point Vⱼ in the neighbourhood of Vᵢ, as being the weighted sum or linear combination of the following three terms:
a continuity term E_{continuity}(i,Vⱼ) favouring a constant spacing between control points, this term can for example be defined as a function of the distance of Vⱼ from the adjacent control points Vᵢ₋₁ and Vᵢ₊₁ and of the average distance \overline{d} between control points:

$${E}_{continuity} ( i , {V}_{j} ) = \frac{\vert {‖ {V}_{j} - {V}_{i - 1} ‖}^{2} + {‖ {V}_{j} - {V}_{i + 1} ‖}^{2} - 2 {\overline{d}}^{2} \vert}{{Max}_{k} {E}_{continuity} ( i , {V}_{k} )}$$
a second-order regularizing term E_{curvature}(i,Vⱼ) aimed at avoiding overly pronounced curvatures of the active contour, that can be defined, approximating the curvature by finite differences, as:

$${E}_{curvature} ( i , {V}_{j} ) = \frac{{‖ {V}_{i - 1} - 2 {V}_{j} + {V}_{i + 1} ‖}^{2}}{{Max}_{k} {E}_{curvature} ( i , {V}_{k} )}$$
a gradient term E_{gradient}(i,Vⱼ) which attracts the active contour towards fronts of the image (zones of the image corresponding to large gradients), by favouring the fronts whose direction is parallel to the estimated contour: this term can be calculated as a function of the gradient vector G(Vⱼ ) in the neighbourhood of Vⱼ and of the exterior normal nₑₓₜ(i) to the active contour at Vᵢ by:

$${E}_{gradient} ( i , {V}_{j} ) = - \frac{{n}_{ext} ( i ) \cdot G ( {V}_{j} )}{{Max}_{k} G ( {V}_{k} )}$$

The weighting of these terms is defined by the user as a function of the properties of the contour of the object. He can for example reduce the weight of the regularizing term in the case of very irregular shapes. The method of segmentation by active contours, such as described above, relies essentially on the detection of the contour of the object. Advantageously, it is possible to add an extra term favouring the homogeneity of the distribution of the colours and of the texture on either side of the active contour curve so as to improve the quality and the robustness of the segmentation obtained. In a large number of situations, the active contours approach makes it possible to facilitate the segmentation process by automating it. The process is also accelerated on account of the swiftness of convergence of the active contour. Moreover, the correction of the errors in estimating the contour of the object requires on the part of the operator only a few small adjustments of control points of the active contour in the zones of the image where the algorithm has not converged correctly. The use of an algorithm akin to the active contours is also more effective than segmentation based exclusively on discrimination in the colour space. Specifically, the operator works directly on the image and not indirectly through the colour space, thus avoiding toings and froings between the segmentation in the colour space and the visualization of the result in the source image. Furthermore, the reliability and the robustness of the segmentation process are improved by the fact that it takes account of the presence of fronts in the image at the boundary of the object, in addition to the discrimination criterion based on colour. According to the invention, it is advantageous to visualize on a display device the result of the segmentation, so as to allow the operator to manually adjust (for example by modifying the position of a few control points) the estimated contour, as soon as a loss of local accuracy in the contour arises which is not compatible with the requirements thereof.

Step 11 of tracking of the object is carried out in the colour space. This tracking in the colour space is more robust to the fast variations in shape of the contour of the object than a tracking of the object in the spatial domain which requires motion estimation. Relative to the approach of tracking the object in the spatial domain, tracking in the colour space exhibits the advantage of greater robustness in relation to fast changes in the shape of the object and changes that cannot be predicted by motion estimation (nonrigid object, occlusions of the object by another foreground object, 3D motion outside the plane of the image).

According to a particular embodiment, the step of tracking the object in the colour space comprises four steps illustrated by FIG. 2. The first step 21 consists in dividing, in the reference image, the colour space into two domains on the basis of the contour of the object estimated in step 10: an object domain and a background domain. The colour being represented in a determined space (e.g. RGB, HSV), this step consists in isolating in this space, the colours associated with the pixels belonging to the object, i.e. located inside the contour delimiting the segmented object, so as to define the object domain in this colour space. The colours not assigned to the object domain make it possible to define the background domain. The object domain in the colour space is for example defined by the support of the colour histogram of the points located inside the contour of the object delimited at step 10. In order to render the tracking of the object in the course of the sequence more robust to colour variations and in particular to change of illumination, it is advantageous to define the object domain in the colour space by also taking account of the support of the histogram of the colours of the background in the neighbourhood of the object. The idea is to extend the domain defined by the support of the colour histogram of the object up to a line of separation between the support of the histogram of the object and the support of the histogram of the background in the neighbourhood of the object in the colour space. A way to proceed consists in defining the colour domain of the object as the set of the points of the colour space for which the distance to the support of the colour histogram of the object is less than that of the support of the colour histogram of the background in the neighbourhood of the object.

Step 22 consists in defining, in the reference image, a window bounding the object, termed the bounding box. This window makes it possible to track the object the whole way along the video sequence. It is defined as a simple geometric shape, typically a rectangle or an ellipse. The choice of the shape can be made automatically as a function of geometric parameters of the contour of the object estimated in the reference source image. The dimensions of the bounding box are defined so as to guarantee a minimum distance to the estimated contour.

The following step 23 consists in tracking the bounding box in each image of the sequence. This step does not require great accuracy. Specifically, it suffices to guarantee that this window remains outside the object along the sequence, and does not stray too far from the contours of the object, so as to preserve good discrimination properties in the colour space. Accordingly, its tracking can be performed with the aid of an algorithm for tracking objects involving few parameters, and which is robust and inexpensive in terms of calculation load. The “mean shift” or “particle filtering” constitute examples of such algorithms. In these approaches, the object is modelled by a probability distribution, typically representing the distribution of the colours inside a window, for example rectangular, which roughly approximates its contour. A distribution of the colours, termed the reference distribution, is estimated in the reference image. Usually, the tracking of the window pertains only to the translation components of the object and a change of scale parameter. At each image of the sequence, the position and the size of the window approximating the contour of the object are estimated in such a way that the distribution of the colours inside the estimated window corresponds best to the reference distribution.

The “mean shift” algorithm is described in patent U.S. Pat. No. 6,590,999 entitled “Real-time tracking of non-rigid objects using mean shift”. This algorithm is adapted to the invention and consists in determining in the images tracking the reference image the position and the size of the bounding box so as to minimize a distance between the distribution of the colours inside the window in the current image and the reference distribution. According to the algorithm, the position of the window in an image is initialized with the final position of the window determined in the previous image. Thereafter, the window is moved in an iterative manner so as to maximize the Bhattacharyya coefficient between the distribution of the colours inside this window and the reference distribution. The two distributions are estimated by the colour histogram constructed on the basis of the n pixels {xᵢ}_{i=1 . . . n} located inside the window. Defining this histogram as a function b which associates with each pixel xᵢ the index b(xᵢ) of the class (or “bin”) corresponding to the colour of this pixel, and moreover defining a kernel function K(x)=k(∥x∥²), of characteristic width h, for the estimation of the density, for example

$$K ( x ) = \{ \begin{matrix}1 & if ‖ x ‖ < h \\ 0 & if ‖ x ‖ \geq h\end{matrix} ,$$

the value of the distribution of the colours inside the window centered on the position y is defined for the colour u, by the following formula:

$${p}_{u} ( y ) = {C}_{h} {\sum }_{i = 1}^{n} k ( {‖ \frac{y - {x}_{i}}{h} ‖}^{2} ) δ ( b ( {x}_{i} - u ) ) .$$

In this formula, Cₕ is a normalization constant defined by

$${C}_{h} = \frac{1}{{\sum }_{i = 1}^{n} k ( {‖ \frac{y - {x}_{i}}{h} ‖}^{2} )} .$$

The maximization of the Bhattacharyya coefficient is performed for various values of the size of the window bounding the object, and the size selected is that which maximizes the maximum of the Bhattacharyya coefficient.

More precisely, the “mean shift” algorithm consists, given the reference distribution {qᵤ}_{u=1 . . . m} of the colours u of the object and the position of the window y₀ estimated in the previous image, in applying the following steps:
1. initialize the central position of the window in the current image with y₀;
2. estimate the distribution pᵤ(y₀) of the colours in the window of the current image centered at y₀;
3. calculate the Bhattacharrya coefficient ρ between qᵤ and the estimated distribution pᵤ(y₀) where ρ(pᵤ(y₀), qᵤ=\sqrt{pᵤ(yₒ)qᵤ};
4. deduce weights wᵢ on the basis of the following equation

$${w}_{i} = {\sum }_{z = 1}^{m} δ ( b ( xi ) - u ) \sqrt{\frac{{q}_{u}}{{p}_{u} ( {y}_{0} )}} , where \text{:}$$

δ is the Kronecker delta function, and
b is the function which associates with a pixel positioned at xᵢ the value of the class (or “bin”) of the histogram associated with the colour of this pixel;
5. deduce the new position y₁ of the window according to the following equation:

$${y}_{1} = \frac{{\sum }_{i = 1}^{{n}_{h}} {x}_{i} {w}_{i} g ( {‖ \frac{{y}_{0} - {x}_{i}}{h} ‖}^{2} )}{{\sum }_{i = 1}^{{n}_{h}} {w}_{i} g ( {‖ \frac{{y}_{0} - {x}_{i}}{h} ‖}^{2} )} , where \text{:}$$

g(x) is the profile associated with the kernel K(x)=k(∥x∥²), defined by the opposite of the derivative of k(x): g(x)=−k′(x),
h is the characteristic width of the kernel K(x),
n is the number of pixels xᵢ inside the bounding box,
6. estimate the new distribution pᵤ(y₁) of the colours in the window of the current image centered at y₁;
7. calculate the Bhattacharrya coefficient ρ between qᵤ and the estimated distribution pᵤ(y₁) where ρ(pᵤ(y₁), qᵤ)=\sqrt{pᵤ(y₁)qᵤ};
8. so long as ρ(pᵤ(y₁), qᵤ)<ρ(pᵤ(y₀), qᵤ) replace y₁ by

$$\frac{1}{2} ( {y}_{0} + {y}_{1} ) ;$$
9. If ∥y₁−y₀∥<ε, the final position of the window in the current image is y₁ and the algorithm stops, otherwise the algorithm resumes at step 1 henceforth using y₁ as reference position of the window in place of y₀.
   The size of the window is determined by making the algorithm above converge with various window sizes representing fractions of the initial size (for example 0.9, 1.0 and 1.1 times the size of the initial window). The size of the window employed is that leading to the largest value of the maximum of the Bhattacharrya coefficient after convergence.

The particle-filtering method can also be used to track the bounding box. This method is more precisely described in the document entitled “Color-Based Probabilistic Tracking” published in the proceedings of the “European Conference on Computer Vision” conference, volume 1, pages 661 to 675, 2002 by P. Pérez, C. Hue, J. Vermaak and M. Gangnet. An advantageous solution which makes it possible to circumvent the inaccuracies of the algorithm for tracking the bounding box consists in detecting the presence of colours belonging to the object on the edges of the bounding box. In this situation, a progressive enlargement of the window until satisfaction of the non-overlap constraint between the colours at the edge of the window and the colours of the object makes it possible to correct the defects of the motion estimation. It is also advantageous to display the evolution of the bounding box along the sequence so as to allow the operator to interrupt the tracking in the event of divergence of the algorithm, then to reposition the window correctly and to continue the tracking.

Step 24 consists in segmenting the object in each image of the sequence on the basis of the tracking of the bounding box along the sequence and of the object domain defined in the colour space and identified in the reference image. More precisely, this step consists in constructing, for each source image of the sequence, a binary classification map inside the bounding box, by assigning to each pixel one of the two labels “object” or “background” as a function of the membership of its colour in one of the object or background domains identified during step 21. Advantageously, it is possible to “clean” this binary map by applying to it mathematical morphology posterior processings (or post-processings) such as closure or opening. These post-processings have the effect of removing small isolated zones.

Advantageously, the object domain in the colour space is updated periodically. The tracking of the object is then applied to several subsequences, inside which the object domain discriminating the object from its neighbourhood in the colour space is regarded as invariant. This updating can make it possible to circumvent the changes of illumination which modify the colours of the object along the sequence as well as modifications of the background in the neighbourhood of the object caused by its relative motion in relation to the object.

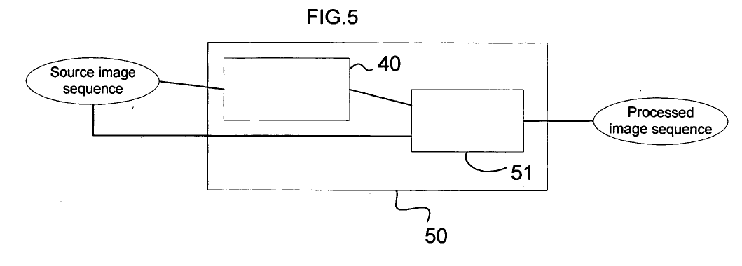

The present invention also relates to a segmentation and object tracking device referenced 40 in FIG. 4 which implements the method described previously. Only the essential elements of the device are represented in FIG. 4. The device 40 comprises in particular: a random access memory 42 (RAM or similar component), a read only memory 43 (hard disk or similar component), a processing unit 44 such as a microprocessor or a similar component, an input/output interface 45 and a man-machine interface 46, These elements are linked together by an address and data bus 41. The read only memory 43 contains the algorithms implementing steps 10 and 11 of the method according to the invention. On power-up, the processing unit 44 loads and executes the instructions of these algorithms. The random access memory 42 in particular comprises the programmes for operating the processing unit 44 which are loaded on power-up of the appliance, as well as the images to be processed. The inputs/outputs interface 45 has the function of receiving the input signal (i.e. the sequence of source images) and outputs the result of the tracking of objects according to steps 10 and 11 of the method of the invention. The man-machine interface 46 of the device allows the operator to interrupt the processing and to manually adjust the contour of an object at each step of the method, as soon as a loss of accuracy in the contour arises which is not compatible with the requirements thereof. The results of the segmentation in each image are stored in random access memory then transferred to read only memory so as to be archived with a view to subsequent processings. The man-machine interface 46 in particular comprises a control panel and a display screen. In the case of a device dedicated to colour correction applications, the control panel is an improved keyboard which can comprise interface elements such as light pen and “balls” allowing adjustment of the gains of the colour components.

The device for segmenting and tracking objects can also be used in an image sequence post-production device referenced 50 in FIG. 5. In this case, the information provided by the device 40 is used to process a video sequence—for example a film—in post-production with the aid of processing means 51. These means can make it possible to perform one of the following processings:
secondary colour correction which consists in modifying the shot of an object in a scene (for example a face);
video mixing (or “compositing”) which consists in extracting a particular object from a scene so as to insert it into another scene;
special effects (for example, removal of an foreground object and replacement by the background) ; and/or
restoration of movies, and more particularly removal of degraded zones in the image resulting from defects on the film.

The invention is not limited to post-production applications but can also be used for various other applications such as:
Video coding: improvement of the compression rate by coding the object in a single frame then transmitting only its variations of shape and of position;
Indexation: extraction of semantically pertinent information on the content of the images; and
More generally, all the processes which require a processing adapted to each of the objects in the image.

1. Method for tracking an object in a sequence of images, each image comprising pixels or image points with each of which is associated at least one value in a determined representation space, termed the colour space, wherein it comprises the following steps:
segmenting, in the spatial domain, said object in an image of the sequence, termed the reference image, by estimation of its contour; and
tracking the contour of said object in the other images of the sequence on the basis of the values associated, in said color space, with the pixels of said object segmented in said reference image.

2. Method according to claim 1, wherein the step of tracking the contour of said object comprises the following steps:
determining an object domain in said colour space representative of the segmented object in said reference image;
determining a window bounding said object, termed the bounding box, in said reference image;
tracking the position of said bounding box in said other images of the sequence; and
segmenting said object in said other images of the sequence on the basis of said position of said bounding box in each of said other images and on said object domain in said colour space.

3. Method according to claim 2, wherein the step of segmenting said object in said other images of the sequence consists, for an image of the sequence, in associating with each pixel of said image located inside said bounding box a label indicating if said at least one value associated with said pixel belongs or does not belong to said object domain defined in said colour space.

4. Method according to claim 1, wherein the step of tracking said bounding box is performed using a region particle filtering algorithm based on the colour of said region.

5. Method according to claim 1, wherein the step of tracking said bounding box is performed using a mean shift algorithm.

6. Method according to claim 1, wherein the step of segmenting said object in said reference image is performed using an algorithm based on active contours.

7. Method according to claim 1, wherein the step of segmenting said object in said reference image is performed using an algorithm based on level sets.

8. Method according to claim 1, wherein said reference image is the first image of the sequence.

9. Method according to claim 1, wherein said colour space lies in the following set:
(red, green, blue);
(hue, saturation, luminance); and
(hue, saturation, value).

10. Device for tracking an object in a sequence of images, each image comprising pixels or image points with each of which is associated at least one value in a determined representation space, termed the colour space, wherein it comprises:
means for segmenting, in the spatial domain, said object in an image of the sequence, termed the reference image, by estimation of its contour; and
means for tracking the contour of said object in the other images of the sequence on the basis of the values associated, in said color space, with the pixels of said object segmented in said reference image.

11. Device according to claim 10, wherein it implements the tracking method according to claim 1.

12. Device for post-production of sequences of images wherein it comprises means for processing said sequence, and a device for object tracking according to claim 10.

13. Device according to claim 12, wherein the processing means are colour correction means.
